(19) United States
(12) Patent Application Publication
(10) Pub. No.: US 2016/0173664 A1
(43) Pub. Date: Jun. 16, 2016

(54) Tactile Keypad for a Device Having a Touch Sensitive Display

(71) Applicant: Marcus LEWIS, Ross-on-Wye, Herefordshire (GB)

(72) Inventor: Marcus Lewis, Ross-on-Wye, Herefordshire (GB)

(21) Appl. No.: 14/905,899

(22) PCT Filed: Jul. 17, 2014
(86) PCT No.: PCT/GB2014/052183

§ 371 Date: Jan. 18, 2016

(30) Foreign Application Priority Data
Jul. 18, 2013 (GB) 1312883.0

(51) Int. Cl. H04M 1/02; H04B 1/3888; G06F 1/16; G06F 3/02; G06F 3/0488

(52) U.S. Cl. CPC H04M 1/026; G06F 3/0202; G06F 3/04886; G06F 3/0227; G06F 1/1662; H04B 1/3888; H04M 1/0216; G06F 2203/04809; H04M 2001/0204

(57) ABSTRACT

A keypad comprises a support adapted, in use, to overlie but be spaced apart from part of a touch screen of a device, the support 16 carrying a plurality of keys, each of which is movable relative to the support, being moveable between a raised, rest position and a depressed position, biasing mean being provided to urge each key towards its rest position, each key carrying a conductive material pad which, when the key occupies its depressed position, contacts the surface of the touch screen.

This invention relates to a keypad, and in particular to a keypad adapted for use with devices having a touch screen such as certain mobile telephone devices, tablet computer devices and the like.

It has become increasingly common for mobile telephone devices, especially so-called smart-phones, tablet computer devices and the like to include touch screens instead of or, in some cases, in addition to a conventional keyboard or keypad. In many cases, where the user is operating the device in a mode in which text is to be entered, such as when typing an email or sms message, or when using a number of other applications which may be provided on the mobile telephone device or tablet computer device, it is usual for the screen to display an image of a keyboard or keypad, and for the user to enter the required text by successively touching the relevant key-image parts or areas of the screen, either with his finger or using a suitable stylus.

Whilst such arrangements operate satisfactorily, some users find their use inconvenient in part because the key-image parts or areas of the screen associated with each key, whilst displayed, cannot be felt by the user. Furthermore, as all the user is required to do is to touch the relevant areas of the screen, there is no tactile feedback to the user to confirm whether or not the device has registered that the relevant area has been touched.

Attempts to mitigate against this have been made by providing auxiliary keypads which either plug into the telephone or tablet device, or communicate therewith using, for example, a Bluetooth communications link. However, such arrangements are complex and, accordingly, tend to be relatively expensive, and are often cumbersome to use, especially whilst on the move.

It is an object of the invention to provide a keypad of simple and convenient form and suitable for use in such applications and in which at least some of the disadvantages set out hereinbefore are of reduced effect or are overcome.

According to the present invention there is provided a keypad comprising a support adapted, in use, to overlie but be spaced apart from part of a touch screen of a device, the support carrying a plurality of keys, each of which is movable relative to the support, being moveable between a raised, rest position and a depressed position, biasing mean being provided to urge each key towards its rest position, each key carrying a conductive material pad which, when the key occupies its depressed position, contacts the surface of the touch screen.

The keys may be separate integers, or alternatively may form parts of a flexible keyboard.

By appropriately laying out the keys on the support and appropriately positioning the pads so that depression of each key results in the pad contacting the corresponding key-image part or section of a keypad display provided on the touch screen, it will be appreciated that the keypad can be used to enter text or the like. The keys provide a tactile feedback to the operator, both providing feedback as to when a key has been depressed and also providing a clearly identified key area which the user can feel with his fingertips. It is thought that such an arrangement will assist a user in achieving a good level of typing accuracy.

Conveniently the support is capable of being moved relative to the device between an in use position in which it overlies the touch screen and a stowed position in which it does not obstruct the touchscreen, allowing substantially the full area thereof to be viewed. The support may be moved between these positions in a number of ways, for example by sliding or by being removed from the device. However, it is preferred that the support be pivotally mounted relative to the device such that it can be pivoted between its in use position and its stowed position. Conveniently, the support is located behind the device when in its stowed position.

The pivotal mounting of the support is conveniently achieved by means of a double hinge.

The support could be permanently attached to the device, for example being hinged to a part of the housing thereof. Alternatively it may be pivotally connected to a removable case securable to the housing of the device.

Preferably a retainer arrangement is provided to retain the support against movement when occupying its in-use and stowed positions. By way of example, the retainer arrangement may be of magnetic form.

Preferably, the pads are located within the support when the keys occupy their rest position. Accordingly, when the support is in its stowed position, the pads do not project from the support. The risk of damage to the pads, or damage to other items resulting from them becoming caught upon the pads, is thus reduced.

In some devices, certain of the keypad key-image parts or areas are displayed in a different colour to indicate when they are activated. By way of example, an area which serves as a caps lock key, or an area operable to switch the keypad between a text entry mode and a numeric or symbol entry mode may be displayed in a different colour when activated. Conveniently, the corresponding keys of the keypad are of transparent or translucent form such that the difference in colour of the displayed key-image part can be viewed by the user to provide an indication that the particular function is activated. The underside of the keys may be provided with a layer of a light transmitting membrane which functions similarly to a light pipe to assist in and amplify the provision of this effect and, for example, resulting in the user being given the impression that the key has been illuminated when contact is made between the layer carried by the key and the touchscreen.

The invention will further be described, by way of example, with reference to the accompanying drawings, in which:

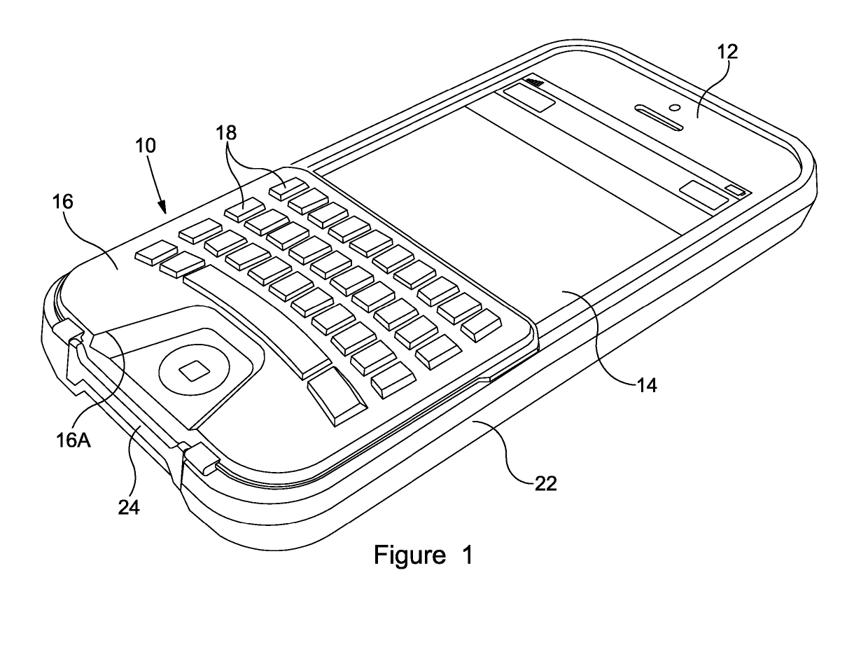

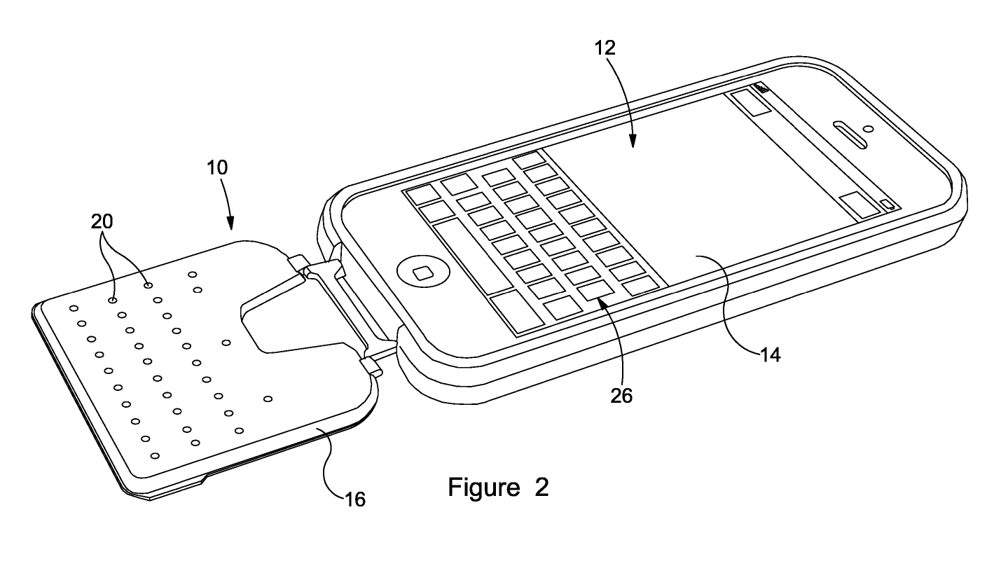

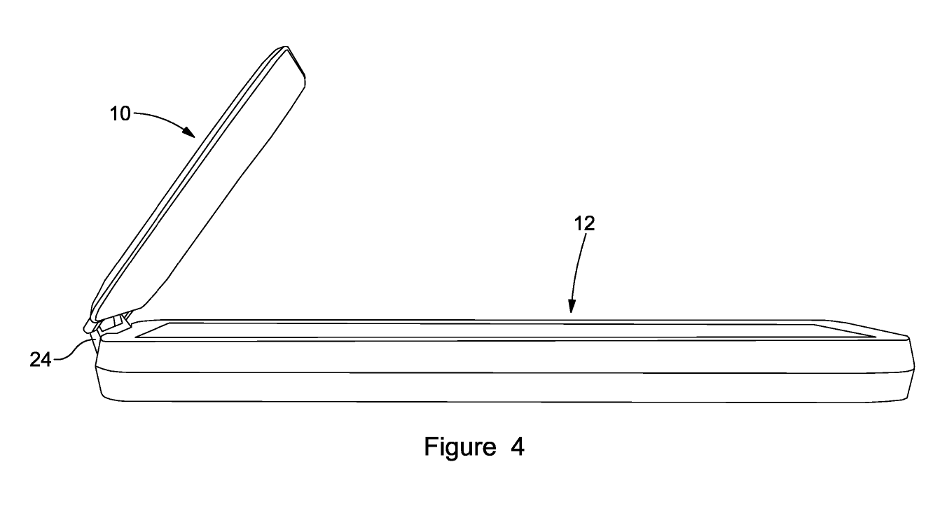

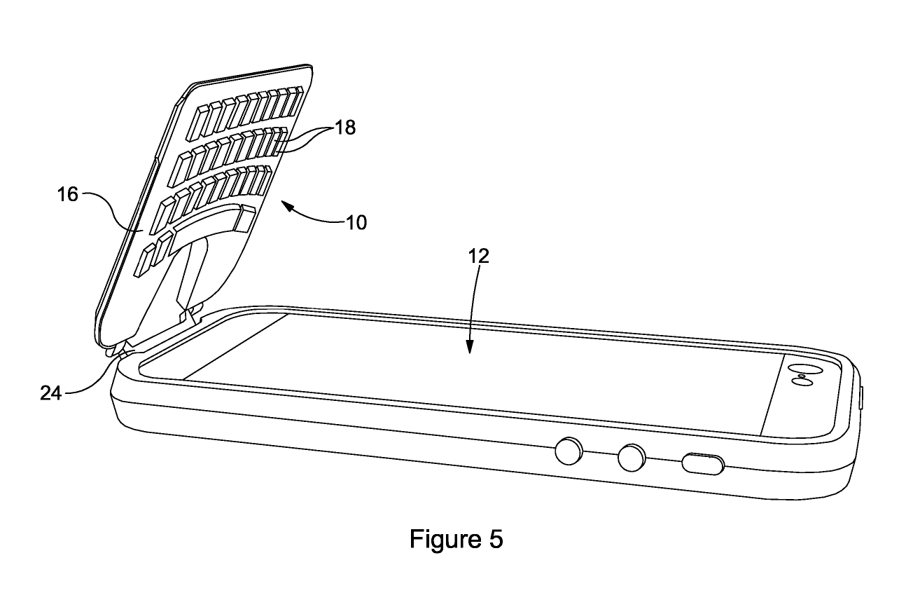

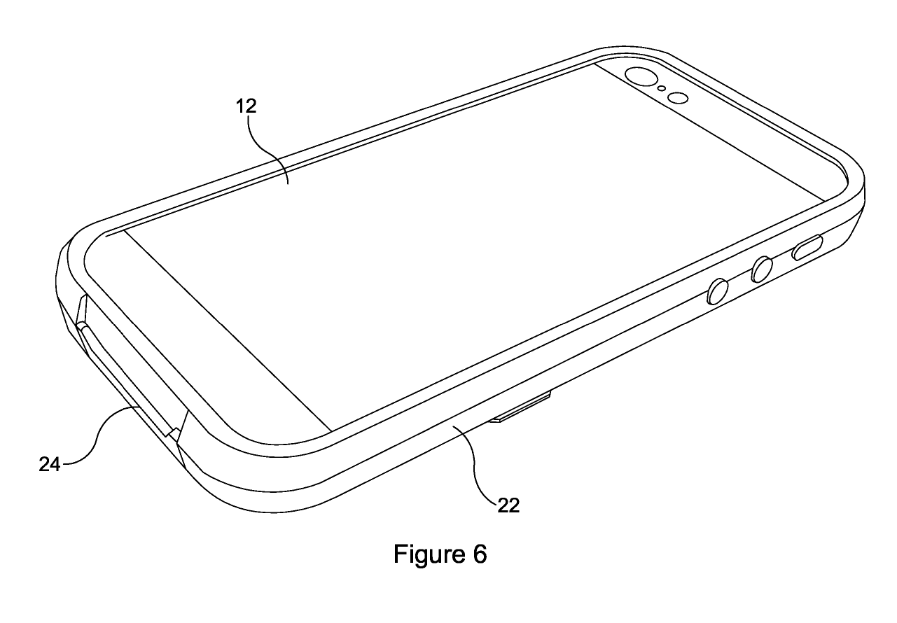

FIGS. 1 to 6 are a series of perspective views of a keypad in accordance with an embodiment of the invention in various positions, in use with a mobile telephone device; and

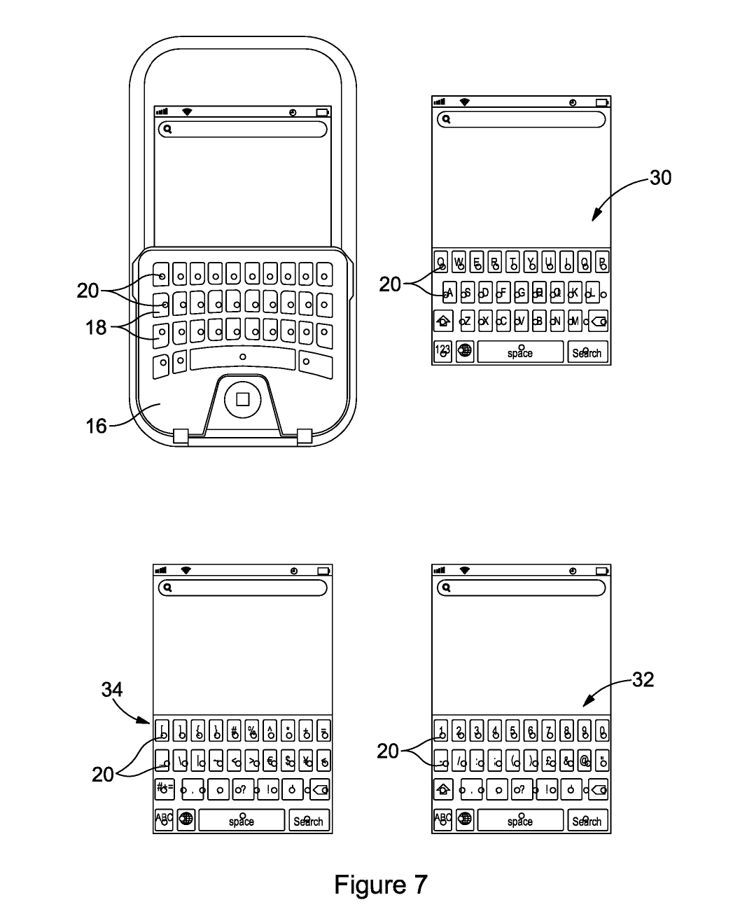

FIG. 7 is an illustration showing the operation of the keypad under various operating modes.

Referring to the accompanying drawings, a keypad 10 in accordance with one embodiment of the invention is illustrated. The keypad 10 is illustrated in use in conjunction with an associated mobile telephone device 12 of the type having a touchscreen 14. Whilst illustrated in conjunction with a mobile telephone device 12, it will be appreciated that the invention is not restricted to such use, and may be used in conjunction with other devices including touchscreens, for example tablet computer devices or the like. Furthermore, whilst one form of mobile telephone device 12 is illustrated, the invention is suitable for use with other forms or designs of mobile telephone device.

The keypad 10 comprises a support 16 in the form of a plastics material panel, moulded so as to define a series of apertures. Within each aperture is located a respective key 18.

The keys 18 are each movable between a rest, extended position in which they project from an upper surface of the support 16, and a depressed position. Each key 18 is biased, for example by respective springs or by the use of other biasing means (not shown), towards its respective rest position.

Whilst in the arrangement illustrated separate keys 18 are provided, arrangements are possible in which the keys 18 are defined by regions of a common flexible keyboard.

The underside of each key 18 is provided with a pad 20 of an electrically conductive material. By way of example, each key 18 may be moulded or shaped to include a projection, an end surface of which is provided with one or more layers of a conductive paint or the like, defining the respective pad 20. It is envisaged that the conductive paint may comprise a silver oxide paint. A coating of shellac or a micro-sprayed resin may be provided to provide protection for the paint, and to minimize the risk of damage to the touchscreen 14. Alternatively, the pads 20 could be of a capactive polymer form.

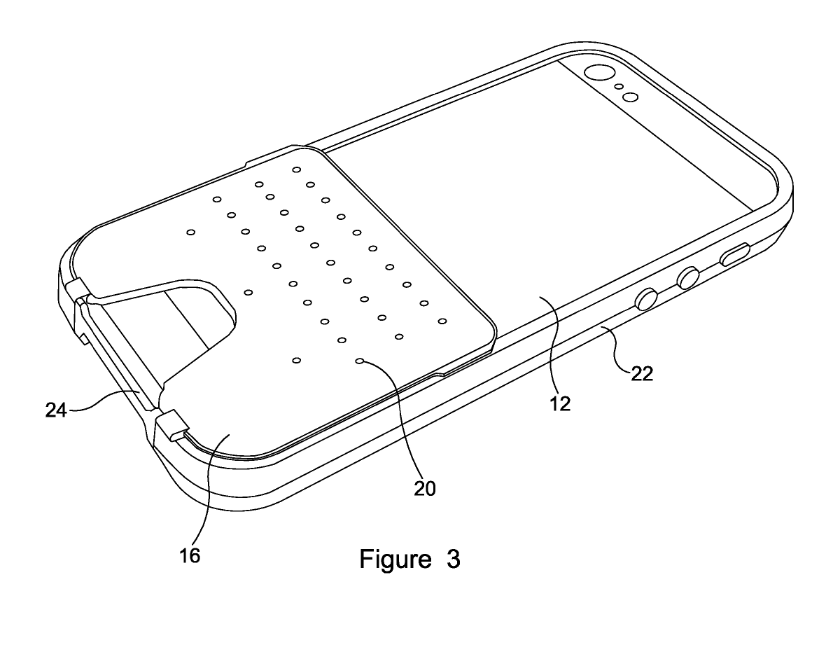

In the embodiment illustrated, the support 16 is pivotally connected to a case 22 which can be secured to the device 12 in any convenient manner. The pivotal connection takes the form of a double hinge, comprising a hinge plate 24 which is pivotally connected to the case 22 and is also pivotally connected to the support 16. Each pivotal connection is capable of pivoting through a large angle sufficient to allow movement of the support 16 between an in-use position, for example as shown in FIG. 1, in which the support 16 overlies part of the touchscreen 14 of the device 12, and a stowed position, for example as shown in FIG. 3, in which the support 18 overlies the rear of the device 12. Conveniently a retainer arrangement (not shown) is provided to retain the support 16 in its stowed and in-use positions. By way of example, small magnets may be affixed to or embedded into appropriate parts of the support 16 and/or case 22 such that when the support 16 is in its in-use position, it is held in position by magnetic attraction, and likewise when the support 16 occupies its stowed position it is retained in that position by magnetic attraction. Of course, it will be appreciated that the use of magnets represents just one of many ways in which the support 16 can be retained against movement.

In the arrangement illustrated, the support 16 is provided with a cut-out 16a such that, when in its in-use position, access to an actuator provided on the device 12 is still possible.

The design of the support 16 and case 22 is such that when the support 16 occupies its in-use position, it overlies, but does not touch, part of the touchscreen 14. It is important that the support 16 remains slightly spaced from the touchscreen 14 to ensure that accidental contact with the touchscreen 14 is avoided, thereby avoiding the accidental touching of parts of the touchscreen 14 and accidental entry of text into the device 12. Not only is the support 16 held in a position in which it is spaced from the touchscreen 14, but the support 16 is also designed so as to be able to withstand the application of loads thereto, applied to the keys, in use, such that the support 16 does not deflect sufficiently far to come into contact with the touchscreen 14. To assist in ensure that contact between the support 16 and the touchscreen 14 is avoided, the support 16 may be of slightly curved, convex form.

When in their rest positions, the keys 18 adopt a position in which the pads 20 do not significantly project from the support 16. The risk of damage to the pads 20, when the support is in its stowed position, or of the pads catching upon other items adjacent the device 12, is thus minimized.

In use, when a user wishes to input text, the keypad 10 is moved to its in-use position in which it overlies part of the touchscreen 14. The part of the touchscreen 14 over which the keypad 10 is positioned is the part of the touchscreen 14 upon which an image 26 of a keyboard is displayed. The image 26 defines a series of key-image parts, touching of each of which results in the entry of the displayed character. The user enters the required text by successively depressing the appropriate ones of the keys 18 of the keypad 10. Upon one of the keys 18 being depressed, the conductive end of the associated projection and pad 20 of that key 18 will move to a position in which it touches the touchscreen 14. The position of the projection and pad 20 associated with the key 18 is chosen to ensure that the projection and pad 20 moves into contact with the corresponding key-image part of the displayed keypad image 26. The engagement of the end of the projection and pad 20 with the touchscreen results in a local change capacitance or resistance of the touchscreen 14 which is sensed by the device 12 and triggers the device 12 in such a manner as to result in the input of the associated character displayed on the associated key-image part. The manner in which the engagement of the pad 20 with the touchscreen 14 is sensed is not of relevance to the invention and will not be described herein in further detail.

It has been found that in certain applications, each pad 20 must have an area greater than a predetermined minimum area in order to engagement of the pad 20 with the touchscreen 14 to be sensed, and the design and layout of the pads 20 is such as to take this into account.

It will be appreciated that the layout of the keys 18 may not exactly correspond with the positions of the corresponding key-image parts of the displayed keypad image 26 and that, accordingly, the position of the projection and pad 20 associated with each key 18 has to be carefully designed to ensure that depression of each key 18 results in the input of the correct, corresponding character.

To reduce the size of the keypad image 26, it is common for certain of the key-image parts of the displayed keypad image to be used to switch between entry modes, the keypad image changing depending upon which entry mode is selected. By way of example, as shown in FIG. 7, the device 12 may be switched between a text entry mode in which the key-image parts of the displayed keypad 30 take substantially the appearance of the keys of a QWERTY layout keypad, a numeric entry mode in which the key-image parts of the displayed keypad 32 take the form of number keys and associated symbols and a symbol entry mode in which the displayed keypad 34 displays a range of symbols. Conveniently, corresponding ones of the keys 18 are used to trigger switching between these entry modes, and the appropriate ones of the keys 18 are conveniently provided with additional markings to clearly indicate which characters are to be input in each respective entry mode. As shown in FIG. 7, the sizes, positions and layout of the key-image parts of the displayed keypad may vary between entry modes, additional care must be taken in designing each key 18 and the position of the projection and pad 20 thereof to ensure that, in use, depression of each key 18 results in the entry of the desired character.

As shown in FIG. 7, for example, when in the text entry mode, the key-image parts of each row are staggered relative to the adjacent rows. In other operating modes, some of the rows may be aligned with one another to form columns.

As shown in FIG. 7, in order to accommodate the various entry modes, the locations of the pads 20 (the locations of which are shown in FIG. 7) must be carefully selected so that they overlie the desired parts of the touchscreen in all of the various modes. By way of example, the pad 20 of the key 18 used to enter the letter ‘a’ in the text entry mode is positioned so as to just touch the left hand edge of the ‘a’ key-image part. Such positioning is required to ensure that the same key is able to touch operate the ‘_’ key-image part when operating in the symbol mode and the ‘-’ key-image part when operating in the numeric input mode. When operating in these modes, the pad 20 just touches the right hand side of the key-image areas.

Depending upon layouts and the like, it may be necessary to carefully control both the left-right positions of the pads 20, and the vertical positions thereof on the keys 18.

In some of the operating modes, certain of the keys may be redundant.

It is envisaged that each pad 20 will be of around 1.5-2 mm diameter.

It is thought that it will often be the case that a number of the keys 18 will overlie a plurality of the key-image parts of the displayed keypad, and this provides a degree of design flexibility.

As mentioned hereinbefore, certain of the key-image parts are used to switch between entry modes. In some devices 12, the colour of the respective key-image part may be changed to provide a visual indication that the relevant key-image part has been selected. By way of example, if the shift key-image part has been selected to switch between lower and upper case text entry, the relevant key-image part may be displayed in a different colour to emphasise this. Conveniently, at least the keys 18 associated with those key-image parts are of a transparent or translucent material so as to allow the user to see that the relevant entry mode has been selected.

A layer of a light transmitting membrane material may be applied to the underside of each key, or at least some of the keys, the membrane being arranged to operate in a manner similar to a light pipe such that when contact is established between the membrane carried by the key and the touchscreen, the key will appear to be illuminated. As a result, a positive feedback is provided to the user to indicate that the key has been actuated.

It will be appreciated that different designs of device 12 utilize different keypad image layouts, and accordingly different designs of keypad 10, with appropriately positioned keys 18, with the pads 20 appropriately positioned thereon, may be required to operate with the different designs of device 12.

Whilst described as separate components, the keys 18 could be integral with, but moveable relative to, the support 16 as a result of flexing of parts of the keys 18, if desired.

Whilst the arrangement described hereinbefore is in the form of a keypad 10 pivotally connected to a case 22 for attachment to a device 12, and thus will typically be retrofitted to an existing device 12, the invention is also applicable to keypads which are designed to be permanently pivotally connected to the housing of a device, whether supplied as part of the device or supplied as an extra for retrofitting thereto. Although pivotal connection of the support 16 is described herein, it will be appreciated that the invention is not restricted in this regard, and that the support 16 may be otherwise moveable between an in-use position and a stowed position.

The case 22 may perform some additional functions. For example, it may serve as a protective case for the device, reducing the risk of damage thereto. It may further house an auxiliary battery, allowing the overall battery life of the device to be enhanced. In such an arrangement, an electrical connection between the case 22 and the device will be provided to permit the device to make use of the battery charge.

Where the case 22 includes an auxiliary battery, then it may also be desired to incorporate, for example, one or more LEDs into the keypad so that, for example, upon depression of the keys, or certain of the keys, the depressed ones of the keys are illuminated. Where a light transmitting membrane is present, as described hereinbefore, then this illumination may be achieved by the use of one or more LEDs positioned so that the light from the LEDs enters the parts of the membrane associated with the depressed ones of the keys to provide illumination thereof. Whilst the use of a battery provided within the case 22 may be used to power such LEDs, it will be appreciated that other arrangements to power the LEDs are possible.

The description hereinbefore is of one embodiment of the invention. It will be appreciated, however, that a number of modifications and alterations may be made thereto without departing from the scope of the invention as defined by the appended claims.

1. A keypad comprising a support adapted, in use, to overlie but be spaced apart from part of a touch screen of a device, the support carrying a plurality of keys, each of which is movable relative to the support, being moveable between a raised, rest position and a depressed position, biasing mean being provided to urge each key towards its rest position, each key carrying a pad which, when the key occupies its depressed position, contacts the surface of the touch screen.

2. The keypad according to claim 1, wherein the support is capable of being moved relative to the device between an in use position in which it overlies part of the touch screen and a stowed position in which it does not obstruct the touchscreen, allowing substantially the full area thereof to be viewed.

3. The keypad according to claim 2, wherein the support is movable between the in use and stowed positions by sliding or by being removed from the device.

4. The keypad according to claim 2, wherein the support is movable between the in use and stowed positions by being pivotally mounted relative to the device such that it can be pivoted between its in use position and its stowed position.

5. The keypad according to claim 2, wherein the support is located behind the device when in its stowed position.

6. The keypad according to claim 4, wherein the pivotal mounting of the support is achieved by means of a double hinge.

7. The keypad according to claim 1, wherein the support is permanently attached to the device.

8. The keypad according to claim 7, wherein the support is hinged to a part of the housing of the device.

9. The keypad according to claim 1, wherein the support is pivotally connected to a removable case securable to the housing of the device.

10. The keypad according to claim 1, further comprising a retainer arrangement to retain the support against movement when occupying its in-use and stowed positions.

11. The keypad according to Claim 10, wherein the retainer arrangement is of magnetic form.

12. The keypad according to claim 1, wherein the pads are located within the support when the keys occupy their rest position.

13. The keypad according to claim 1, wherein at least one of the keys is of transparent or translucent form.

14. The keypad according to claim 1, wherein the pads are of capacitive polymer form.

15. The keypad according to claim 1, wherein the pads include a layer of a silver oxide paint.

16. The keypad according to claim 1, wherein a light transmitting membrane is associated with the underside of at least one of the keys.

17. The keypad according to claim 1, further comprising an auxiliary battery connectable to circuits of the device.
